(19) United States
(12) Patent Application Publication
(10) Pub. No.: US 2006/0202588 A1
(43) Pub. Date: Sep. 14, 2006

(54) Coreless generator set

(76) Inventor: Min-Huang Lin, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/429,188

(22) Filed: May 8, 2006

(30) Foreign Application Priority Data
Feb. 12, 2005 (TW) 094221062

(51) Int. Cl. H02K 1/22

(52) U.S. Cl. 310/268

(57) ABSTRACT

The present invention provides a generator, which is coreless with brushes; and the generator has a simple structure for generating electricity with a high efficiency, a high rotation speed and a high power capacity.

### FIELD OF THE INVENTION

The present invention relates to a generator; more particularly, relates to generating electricity with a simple structure to obtain high efficiency, high rotation speed and high power capacity.

### DESCRIPTION OF THE RELATED ART

A prior art is proclaimed in Taiwan as shown in FIG. 9, called “A manual engine generator”. The prior art has two magnetic poles and a brush on a cover 92 of a base 91; a rotor is pivoted between the two poles; a belt pulley 93 at an end of the rotor is driven by an engine; the belt pulley 93 is pivoted on the rotor with a clockwise ratchet 94; a driving axle 96 is pivoted on the other end of the rotor with another clockwise ratchet as well; a turning axle is pivoted in the rotor with a plurality of anticlockwise ratchets; the driving axle 96 is wired with a driving line; a reciprocator 99 is deposed with the driving line for the driving axle 96 to step-turning to and fro in a manual way; a torque device 97 is pivoted and a fastener 98 is fixed on the turning axle; a turning wheel is pivoted at an end of the turning axle with a clockwise ratchet; and, the driving axle 96 is pivoted at an end of the turning wheel with a connecting bolt to obtain a clockwise-rotating returning force. The fastener 98 controls the releasing of the returning force of the turning wheel to rotate the rotor for obtaining a sudden current with the two magnetic poles, so that a required sudden current for starting an engine is obtained. Hence, even when a battery for the engine is run out of power, an electric power can be obtained manually for starting the engine.

Although the prior art is able to generate electric power, the prior art has a rotor with core limiting its rotation speed, so that high rotation, high power capacity and high power density are not attainable on using. Hence, the prior art does not fulfill users' requests on actual use.

### SUMMARY OF THE INVENTION

The main purpose of the present invention is to obtain a simple-structured and highly efficient generator set having high generating capacity, high power density and high rotation speed

To achieve the above purpose, the present invention is a coreless generator set, corn p rising an actuator, a gearbox, a generator having an output unit, and a first rectifier, where the gearbox is connected between the actuator and the generator to transform a rotation speed of the actuator into a high speed according to a specific gear ratio; by the rotating of the generator, electricity is generated to be transferred to the first rectifier through the output unit to be rectified into a direct current voltage. Accordingly, a novel coreless generator set is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 and FIG. 2 are block views showing a first and a second preferred embodiments according to the present invention;

FIG. 3 to FIG. 5 are views showing a first, a second and a third states of use of an actuator according to the first preferred embodiment of the present invention;

FIG. 6 is a cross-sectional view of a gearbox according to the first preferred embodiment of the present invention;

FIG. 7 and FIG. 8 are views showing a first and a second states of use of a generator according to the first preferred embodiment of the present invention; and

FIG. 9 is a view of a prior art.

### DESCRIPTION OF THE PREFERRED EMBODIMENTS

The following descriptions of the preferred embodiments are provided to understand the features and the structures of the present invention.

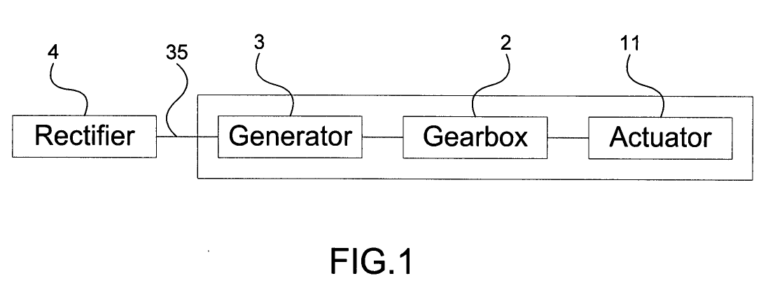

Please refer to FIG. 1, which is a block view showing a first preferred embodiment according to the present invention. As shown in the figure, the present invention is a coreless generator set, comprising an actuator 1 of an engine, a bicycle, an animal or any other power device; a gearbox 2; a brush coreless generator 3 and a first rectifier 4. The gearbox 2 is deposed between the actuator 1 and the generator 3. When a rotation speed of the actuator 1 is inputted into the gearbox 2, the speed is transformed by the gearbox 2 according to a certain gear ratio, such as 1:144, so that the outputted rotation speed of the gearbox 2 is multiplied, such as 144 times, to the original rotation speed of the actuator 1. Hence the rotation speed of the generator 3 is increased to achieve a rapid rotation and a high power generation capacity. An electrical power is outputted from an output unit 35 of the generator 3. The output signal from the output unit 35 is an alternating current (AC) voltage, which is then rectified into a direct current (DC) voltage of 6 volts by a first rectifier 4. The gearbox 2 is used to prevent the rotation speed of the generator 3 and the capacity of power generation from being limited by the rotation speed capacity of the actuator 1.

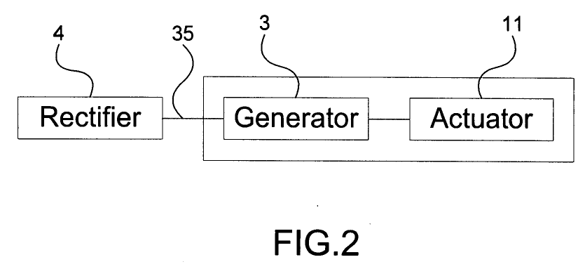

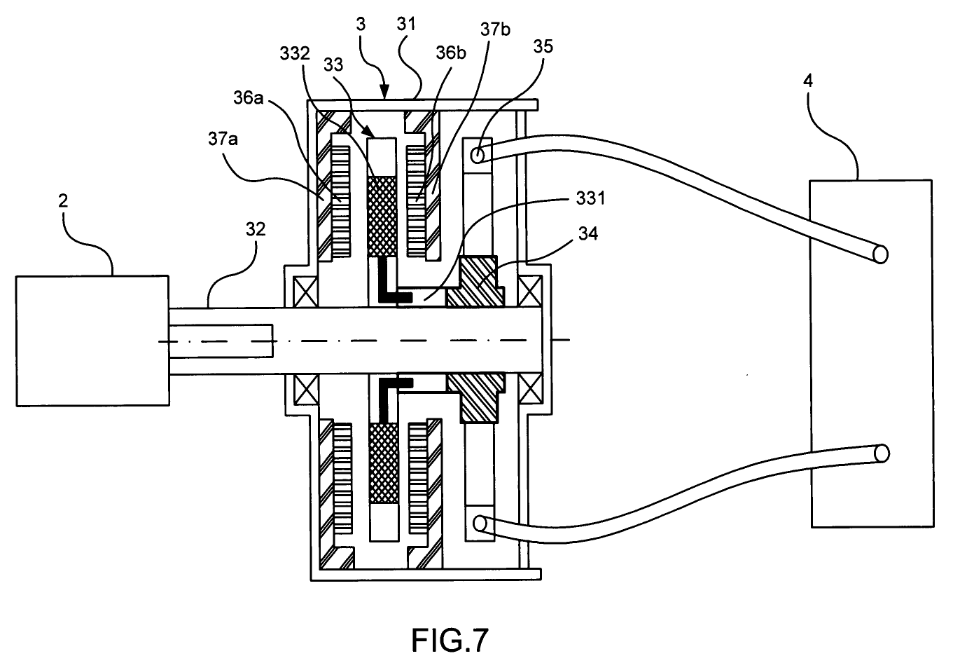

Please refer to FIG. 2, which is a block view showing a second preferred embodiment according to the present invention. As shown in the figure, the present invention is a coreless generator set, comprising an actuator 1, a generator 3 and a first rectifier 4. The actuator 1 moves the generator 3 to produce an electric power. The electric power is outputted from an output unit 35 of the generator 3. The output signal from the output unit 35 is an AC voltage, which is then rectified into a DC voltage of 6 volts by a first rectifier 4. What is different from the first preferred embodiment as shown in FIG. 7 is the lacking of a gearbox, which make the generator 3 be easily limited by the outputted rotation speed of the actuator 1.

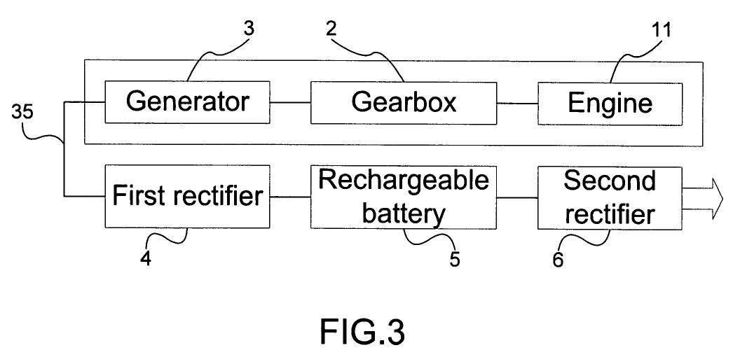

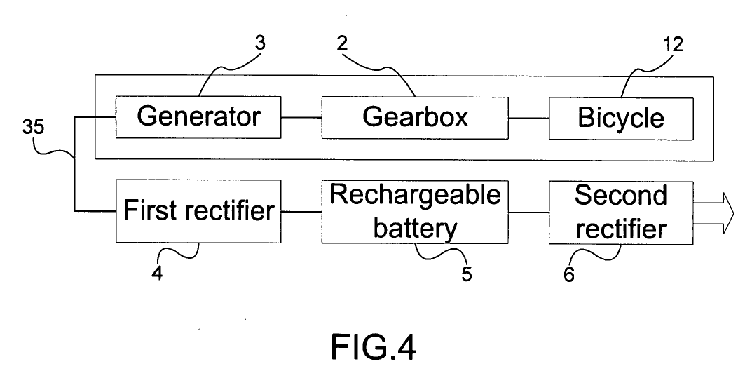

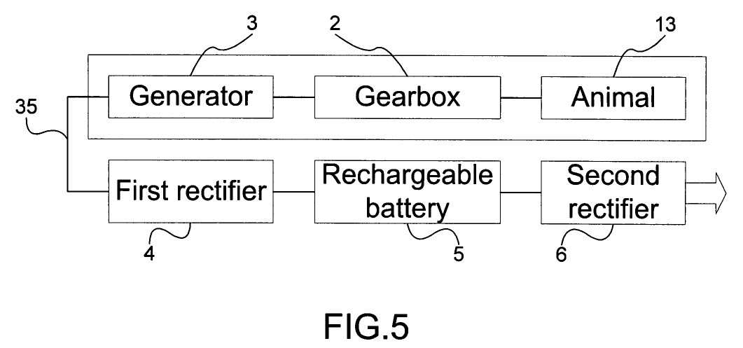

Please refer to FIG. 3 till FIG. 5, which are vies showing a first, a second and a third states of use of an actuator according to the first preferred embodiment of the present invention. As shown in the figures, the present invention comprises an engine 11, a gearbox 2, a generator 3, a first rectifier 4, a rechargeable battery 5 and a second rectifier 6. The engine 11 is an actuator (as shown in FIG. 3). The engine 11 initializes a rotation speed and the gearbox 2 transforms the speed according to a certain gear ratio, such as 1:144, so that the outputted rotation speed of the gearbox 2 is multiplied, such as 144 times, to the original rotation speed. An electrical power is outputted from an output unit 35 of the generator 3. The output signal from the output unit 35 is an AC voltage, which is then rectified into a DC voltage of 6 volts by a first rectifier 4. The electric power is saved with a rechargeable battery 5. Once an electric power is required, the DC voltage within the rechargeable battery 5 is transformed into an AC voltage through the second rectifier 6, which can be used to supply electric power to a household appliance, such as a light, a television or an electrical fan. Besides, the actuator can be a bicycle 12 (as shown in FIG. 4) or an animal 13 (as shown in FIG. 5).

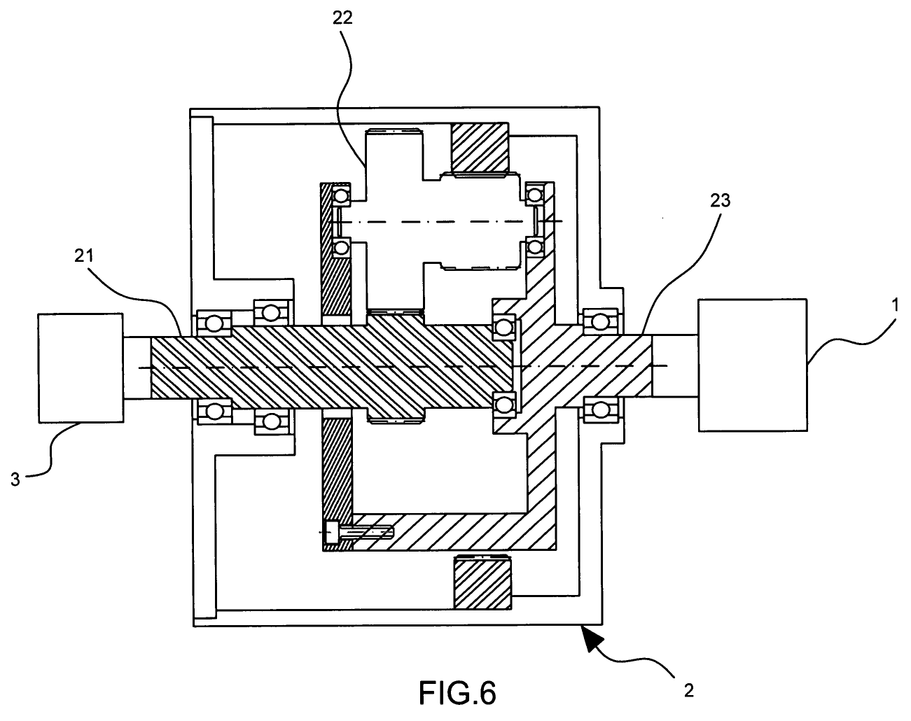

Please refer to FIG. 6, which is a cross-sectional view of a gearbox according to the first preferred embodiment of the present invention. As shown in the figure, a gearbox 2 of the present invention comprises a first spindle 21, a plurality of tower planet gears 22 of sun and planet gears, and a second spindle 23. The second spindle 23 is connected with an actuator 1 and the first spindle 21 is connected with a generator 3. When the second spindle 23 rotates as being driven by the actuator 1, the plurality of tower planet gears 22 are driven to be rotated and further drive the first spindle 21 to rotate as well. Hence, in the end, the generator 3 is driven to obtain an output by rotation with a high speed and a small torque.

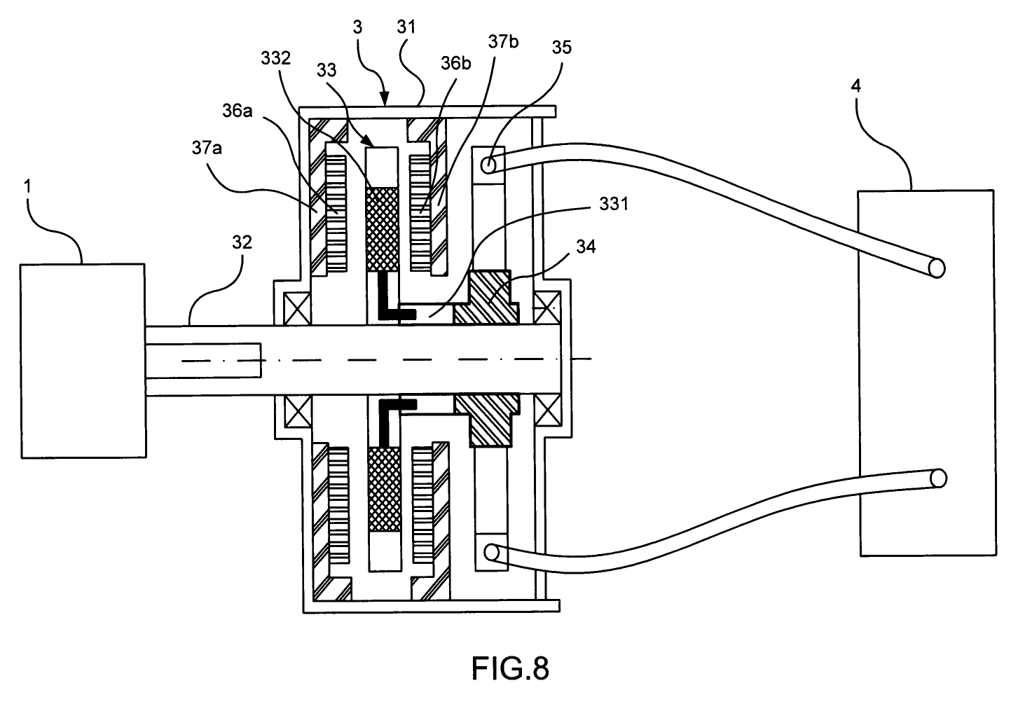

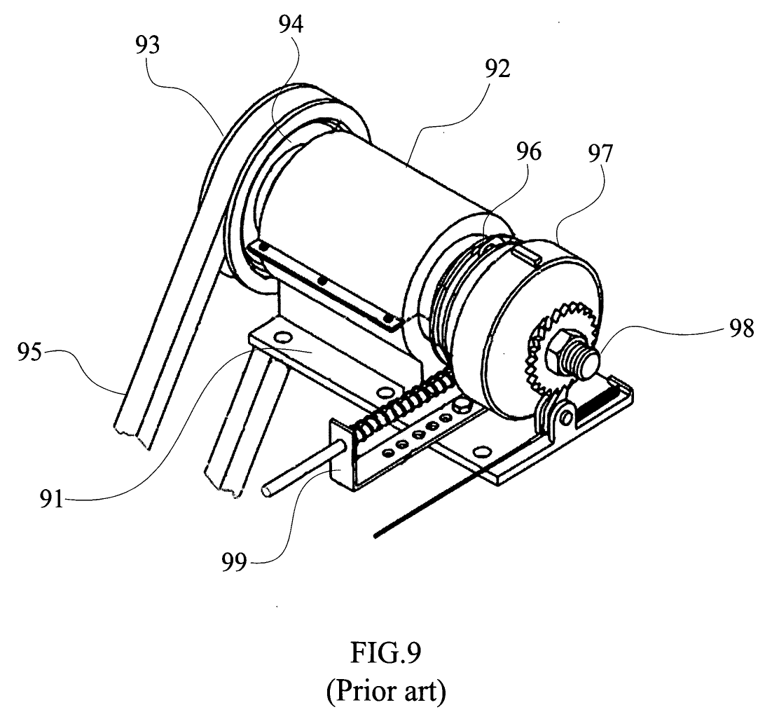

Please refer to FIG. 7 and FIG. 8, which are views showing a first and a second states of use of a generator according to the first preferred embodiment of the present invention. As shown in the figures, the generator of the present invention is a brush coreless generator, comprising a shell 31 having permanent magnets 37a, 37b; a shaft 32; a rotor plate 33 having a commutator 331; two brushes 34; an output unit 35; and a plurality of collar plates 36a, 36b, where the rotor plate 33 is fixed on the shaft 32 and has more than one coil 332; the coil 332 penetrates through two surfaces of the rotor plate 32; the brushes 34 are respectively connected with the commutator 331 with a sliding; the brushes 34 are connected with the output unit 35; the shaft 32 of the generator 3 is connected with the gearbox 2 (as shown in FIG. 7) or the actuator 1 (as shown in FIG. 8); and the output unit 35 is connected with the first rectifier 4.

To sum up, the present invention is a coreless generator set, where a simple-structured and highly efficient generator set is obtained with a high generating capacity, a high power density and a high rotation speed.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A coreless generator set, comprising:
(a) an actuator;
(b) a gearbox, said gearbox connecting to said actuator at an end of said actuator;
(c) a generator, said generator a brush coreless generator, said generator having an output unit;
(d) a first rectifier, said first rectifier connecting to said output unit to output a direct current (DC) voltage.

2. The generator set according to claim 1,
wherein said actuator is selected from a group consisting of an engine, a bicycle and an animal.

3. The generator set according to claim 1,
wherein said gearbox comprises a first spindle; a plurality of tower planet gears; and a second spindle.

4. The generator set according to claim 1,
wherein said gearbox has a gear ratio of 1:144.

5. The generator set according to claim 1,
wherein said generator comprises a shell, a shaft, a rotor plate, two brushes and a plurality of collar plates, said shell having permanent magnets, said rotor plate having a commutator;
wherein said rotor plate is fixed on said shaft and has more than one coil;
wherein said coil penetrates through two surfaces of said rotor plate; and
wherein said brushes are respectively connected with said commutator with a sliding.

6. The generator set according to claim 1,
wherein said DC voltage is 6 volts.

7. The generator set according to claim 1,
wherein said first rectifier is further connected with a rechargeable battery and a second rectifier.

8. A coreless generator set comprising:
(a) an actuator;
(b) a generator, said generator a brush coreless generator, said generator having an output unit; and
(c) a first rectifier, said first rectifier connecting to said output unit to output a DC voltage.

9. The generator set according to claim 8,
wherein said actuator is selected from a group consisting of an engine, a bicycle and an animal.

10. The generator set according to claim 8,
wherein said generator comprises a shell, a shaft, a rotor plate, two brushes and a plurality of collar plates, said shell having permanent magnets, said rotor plate having a commutator;
wherein said rotor plate is fixed on said shaft and has more than one coil;
wherein said coil penetrates through two surfaces of said rotor plate; and
wherein said brushes are respectively connected with said commutator with a sliding.

11. The generator set according to claim 8,
wherein said DC voltage is 6 volts.

12. The generator set according to claim 8,
wherein said first rectifier is further connected with a rechargeable battery and a second rectifier.
